(19) United States
(12) Patent Application Publication
(10) Pub. No.: US 2017/0242711 A1
(43) Pub. Date: Aug. 24, 2017

(54) REMOTE MANAGEMENT OF VIRTUAL APP LIFECYCLE BASED ON CONTEXT AND SOCIAL NETWORK ACTIVITIES

(71) Applicant: International Business Machines Corporation, Armonk, NY (US)

(72) Inventors: Kuntal DEY, New Delhi (IN); Vijay EKAMBARAM, Tamilnadu (IN); Seema NAGAR, Bangalore (IN); Enara C. VIJIL, Croton on Hudson, NY (US)

(21) Appl. No.: 15/052,174

(22) Filed: Feb. 24, 2016

(51) Int. Cl. G06F 9/44; H04L 29/08; G06F 3/0484

(52) U.S. Cl. CPC G06F 9/4443; G06F 3/04842; H04L 67/10

(57) ABSTRACT

Systems and methods for managing app lifecycles on a user device. A device context and a social context are determined. Based on these contexts and a respective set of context related conditions associated each of at least one server based app, a subset of the available server based apps is selected. A respective indicator of a respective user interface element for each server based app within the set of server based apps is sent. User interface inputs for a selected app within the first set of server based apps are received from the user device. The user interface inputs are processed to produce results based on the user interface inputs and the results are sent. The position of user interface elements for the server based apps is also able to be determined and specified in some examples based on the determined context.

### BACKGROUND

The present disclosure generally relates to the field of management of applications on a device, and more particularly to remotely managing the lifecycle of applications based on activities of and context information relating to a user of the device.

User computing equipment, such as cellular phones, personal electronic device, and the like, are increasingly able to host applications to provide useful services or information to a user. The usefulness of having dedicated applications, or “apps,” on a user device has led to an increase in the number of apps that are of interest to a user.

### BRIEF SUMMARY

A method on a server includes determining a first device context for a user device where the first device context being a context of the user device at a first timepoint. The method further includes determining a first social context for a user of the user device where the first social context being a social context of the user of the user device at a first timepoint. The method additionally includes determining, based on the first device context, the first social context, and a respective set of context related conditions associated with each server based app within at least one server based app, a first set of server based apps associated with a first context comprising the first device context and the first social context, the first set of server based apps being a subset of all server based apps available from the server. A respective indicator of a respective user interface element for each server based app within the first set of server based apps is sent. User interface inputs associated with a selected user interface for a selected app within the first set of server based apps are received at a server from the user device based on sending the respective indicator. The user interface inputs are processed to produce results based on the user interface inputs processing, based on receiving the user interface inputs. The results are sent based on the producing.

In one example, a method on a user device includes determining a present user device context and receiving, from a remote processor, a respective indicator of a respective user interface element associated with each respective server based app within a first set of server based apps. Each respective indicator indicating a user interface element to display for selection of its associated server based app. The method further includes receiving, in association with the first set of server based apps, an indication of a device context and determining that the present user device context matches the indication of a device context. The method further includes displaying, based on receiving the respective indicator and based on determining that the present user device context matches the indication of a device context, the respective user interface element associated with each server based app within the first set of server based apps. In an example, the respective user interface elements are displayed on a display along with other user interface elements. The method also includes receiving, based on displaying the respective user interface element, a selection of a selected user interface element that is associated with a selected server based app. In an example, this selection is able to be made by a single interaction with the selected user interface element. The selected server based app executing on the remote processor and interacting with a user interface components of the user device. The method also includes presenting on a display of the user device, based on the selection, a user interface for the selected server based app. The method further includes exchanging with the remote processor, in conjunction with the user interface, information between the selected server based app executing on the remote processor and user interface components of the user device.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various examples and to explain various principles and advantages all in accordance with the present disclosure, in which:

FIG. 1 illustrates a geographic environment, in accordance with one example;

FIG. 2 illustrates shopping center area user device displays, according to an example;

FIG. 3 illustrates example mall area user device displays, according to an example;

FIG. 4 illustrates cloud based app management and deployment environment, according to an example;

FIG. 5 illustrates a user context processing block diagram, according to an example;

FIG. 6 illustrates a present context app management platform process, according to an example;

FIG. 7 illustrates a multiple device contexts app display definition process, according to an example;

FIG. 8 illustrates a social context based icon determination process, according to an example;

FIG. 9 illustrates a user device icon receipt process, according to an example;

FIG. 10 illustrates a user device context adaptation process, according to an example;

FIG. 11 depicts a cloud computing environment according to an embodiment of the present invention;

FIG. 12 depicts abstraction model layers according to an embodiment of the present invention; and

FIG. 13 is a block diagram illustrating one example of an information processing system according to one example.

### DETAILED DESCRIPTION

The below described system and method operate to provide an improved user's experience when using a mobile device to access information or perform other communications associated with businesses or other entities that are relevant to the user's context. In an example, a context of a user device, and therefore a context associated with a user of that device, is determined where the context is able to include a device context of the device and a social context for the user of the device. In some examples, the context is also able to include observed or predicted activities that the user is engaged in. Based on this determined context, which may or may not include activities that are part of the context, processes on a remote server, such as within a cloud based computing infrastructure, perform lifecycle management of various special purpose processing applications, referred to herein as “apps,” on that user device. In an example, such lifecycle management is able to include installation, management, operational support, and de-installation of one or more capabilities on the user device. These capabilities in one example are server based apps that allow a user to perform processing, access data, perform other tasks, or combinations of these, via the user interface of the user device. In an example, a server based app is enabled on the user device by providing a user interface on the device that communicates with, and exchanges data with, a remote computing device such as a server or other cloud based infrastructure. The cloud based infrastructure in an example is able to perform processing, data storage, other operational support, or combinations of these, based on the user interface provided on the user device.

The server based apps that are made available on the user interface of a device in some examples are based on a device context of the user device along with a social context that is based on, for example, any type of information regarding social contacts of the user of the device. The device context of the user device is able to include, for example, data such as location, velocity, environmental contexts, any other condition related to the device or user, or combinations of these. Social context in an example is able to include information regarding social contacts is able to include, for example, information concerning friends or associates of the user including, for example, interests or activities of a friend or associate of the person. Friends or associates are able to be defined by any suitable technique, such as by being included in a person's contact list, identified as a contact in any type of social networking system, by any other technique, or combinations of these. In the following discussion, the term social contact is used to refer to any such friend or associate of a user of a device.

In some examples, the server based apps presented to a user are able to be changed based upon one or both of the activities of the user of the device and the activities of social contacts of that user. For example, if a user of a device is in a shopping area and it is determined that there are no relevant activities of any social contacts of that user, the user is able to be presented with icons of server based apps that are relevant to the user, such as server based apps associated with stores near the user. If it is determined that a social contact of the user is engaged in an activity relevant to the user of the user device, the server based apps presented to the user is able to be altered to reflect those relevant activities. In the example of a user in a shopping area, the icons for server based apps that are presented to a user on that user device are able to be changed when a social contact of the user enters the shopping area. For example, the icons presented to the user are able to reflect shared interests of the user and the social contact who is also in that shopping area. A device used by the social contact is also able to be instructed to display icons for server based apps related to those shared interests of the social contact and the user.

Activities of social contacts that are relevant to a user of a user device and thus be part of the social context of a user in some examples are able to fall into many categories. For example, a social contact's moving into an area that is physically near the user, such as in a shopping mall or other commercial area, can cause icons for server based apps to be displayed to both the user and his or her social contact. Also, selected icons of server based apps are able to be displayed on the user device and the social contact's device when the social contact and the user are performing activities that are similar to a present or anticipated activity of the user. For example, when a user and his or her social contact are both shopping in a store that are in the same retail store chain and that chain has a social network based promotion, icons for server based apps associated with that same particular retail store chain are able to be presented on both the user device and the device of the social contact. The above are merely examples and it is clear that any other activity that is relevant to the user, or combinations of other activities and those listed above, are able to be a basis for selecting icons for server based apps to the user and his or her social contacts based on the activities of the social contacts relative to the interests and activities of the user.

Other ways of determining activities of social contacts that are relevant to a particular user can be based on inferred activities of the user. Activities of a user may be inferred by, for example, the location of the user, such as a location in a shopping mall infers shopping and movement to a particular type of store, such as a clothing store, infers that the user may be interesting in clothes shopping. Other conditions related to the user device, such as if the device is being used to make a call, environmental conditions such as if it is hot or cold near the user, other conditions, or combinations of these, are also able use be used to infer activities of social contacts that are relevant to the user. Other inferences are able to be made based upon a schedule of the user, such as is maintained by the user's calendar on the device or accessible to other processing. A schedule entry indicating that the user is scheduled to meet someone for dinner can infer that the user is interested in eating and that apps related to eating would be of interest to the user and also to the social contact before the scheduled time for dinner, and icons for such server based apps are able to be presented to both the user and his or her social contact prior to the scheduled time for dinner. The schedule of the user, and in some examples the schedule of the user's social contact, is able to include information concerning a location of one or both of the user and the user's social contact prior to the meeting, so that icons for server based apps related to eating in the area where one or both of the user and the user's social contact are scheduled to be prior to the scheduled dinner.

Icons for server based apps are also able to be selected for presentation to the user of a user device, presentation to a social contact of the user, or to both, based upon observed behavior of the user when the user and his or her social contact were in similar situations in the past. For example, it may have been observed on several past occurrences that when the user and a particular social contact are both in a shopping center around a meal time, they meet at a restaurant to eat. Based on this observed historical icons for server based apps for restaurants are able to be shown more prominently, such as near or at the top of a display, presented to both the user and his or her social contact.

The icons for selected server based apps, as well as particular versions of the server based app, that are able to be shown to a user are able to be selected based upon known preferences of the user. For example, the user may be a vegetarian and may indicate this preference in one or more ways. For example, a user is able to specify such a preference for vegetarian eating in a profile list. Such preferences are also able to be indicated less directly, such as by postings on a social media venue. Based on a determination that the user prefers vegetarian meals, icons to display to the user are normally selected for versions of server based apps for restaurants that only present vegetarian meals. In an instance where a social contact to this user indicates that he or she is non-vegetarian, that social contact is normally presented with icons for versions of server based apps that include non-vegetarian meals. In a scenario where the user and that social contact are going to meet for dinner, prior to and up to the time of that scheduled dinner, the user and that social contact are able to be shown icons for versions of server based apps for restaurants that are of interest to both the user and that social contact. For example, the versions of server based apps may include both vegetarian and non-vegetarian meals. In an example, such selection of icons for selected server based apps is based at least on part on the social context of the user of the user device.

Particular icons for server based apps that are presented to a particular user are able to be changed, such as by having new ones added or currently presented ones removed, at any time based upon determined contexts of the device, including both device context, social context that are able to be based on activities in some examples. For example, based on a determination that the location of a user device indicates that the user is entering a restaurant, icons for server based apps associated with other restaurants can be removed from the display of the user device, and icons for server based apps associated with other things, such as movies or other entertainment venues, can be added. In an example of a user's location that is determined to be in a mall around dinner time, the user device is able to present icons for server based apps associated with clothing stores, restaurants, and entertainment venues such as movies. The arrangement of these icons may have placed icons for clothing store related apps above icons for server based apps associated with restaurants and icons for server based apps above those for server based apps associated with entertainment venues. As the user enters a particular restaurant with a person who is a social contact of that user, the ordering of icons presented to the user is able to be modified based on a prediction that the user is going to eat at that particular restaurant and will be interested in social activity afterwards, such as going to a movie. In this example, a new ordering of icons presented to the user is able to place an icon for the server based app for the restaurant that the user is now located in on top of the presentation with icons for server based apps associated with movies located immediately below that icon, and then icons for server based apps associated with clothing stores are placed on the bottom.

In some examples, the icons for server based apps are also able to be displayed on a single display along with icons for local apps, which in one example are apps that are installed on the device. The locations of icons for server based apps are able to be specified at any location on the display. For example, icons for server based apps in some examples are able to be intermingled on the display of icons for local apps in any order or arrangement. In an example, a server based app is able to be accessed by a user by a single tap or by another single interaction with the icon representing that server based app.

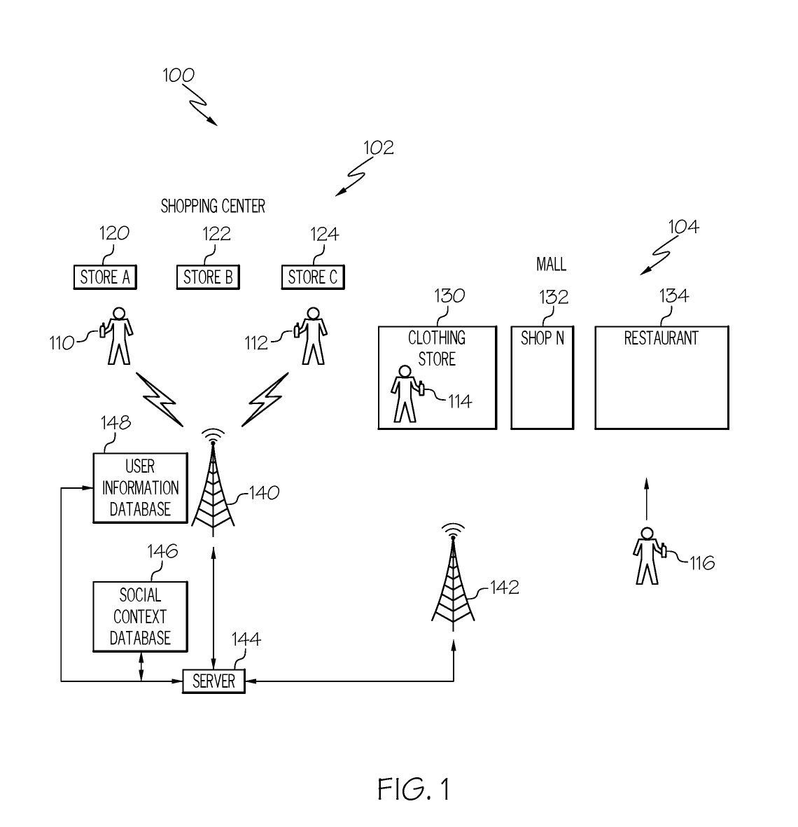

FIG. 1 illustrates a geographic environment 100, according to an example. The geographic environment 100 in this example includes two commercial areas, a shopping center 102, and a mall 104 that includes a number of retail and other consumer oriented businesses. A relatively small number of stores, retail and other consumer oriented businesses are shown in this geographic environment 100 in order to more concisely describe relevant aspects of the operation of the described systems and methods. As is generally understood, such shopping centers and city centers are able to have a large number and a large variety of businesses and other venues that are able to be spread over a generally large geographic area in a variety of configurations over that area.

In the illustrated geographic environment 100, the shopping center 102 includes a store A 102, a store B 122, and a store C 124. In this depiction, these three stores are shown in a line from left to right in the drawing, with store B 122 between store A 120 and store C 124, which are respectively at the ends of this line. A first user 110 and a second user 112 are shown in different areas of the shopping center 102. In the particular configuration of this illustration, the first user 110 is shown near store A 120, and the second user 112 is shown near store B 122 and closer to store C 124 than Store A 120. In this example, the first user 110 and the second user 112 are social contacts with each other, as can be determined by observing that they each indicate that they are friends with each other in their social media profiles.

The mall 104 includes clothing store 130, a movie 132, and a restaurant 134. In this depiction, the clothing store 130, movie 132 and restaurant 134 shown in a rough line from left to right in the drawing, with movie 132 between the clothing store 130 and the restaurant 134, which are respectively at the ends of this line. A third user 114 and a forth user 116 are also shown in different areas of the mall 104. In particular, the third user 114 is shown to be inside the clothing store 130. The fourth user 116 is shown as approaching the restaurant, and is just entering the mall 104. An arrow near the fourth user 116 indicates that the fourth user is in motion and moving towards the restaurant 134. In this example, as described above for the first user 110 and the second user 112, the third user 114 and the fourth user 116 are social contacts with each other such as is also able to be determined by their indicating that they are friends with each other in their social media profiles.

The users in the geographic environment 100 each have a respective user device that wirelessly communicates with a wireless communications infrastructure. In the illustrated geographic environment 100, the user devices are able to wirelessly communicate with either a first wireless communications station 140 and/or a second wireless communications station 142. In general, the user devices are able to communicate, either wirelessly or via a wired connection, through any suitable communications interface. In various examples, user devices used by any of the first user 110, the second user 112, the third user 114, the fourth user 116, or any combinations of these, are able to communicate via cellular data services, short range wireless links such as Wi-Fi®, Bluetooth®, any suitable technique, or combinations of these. In the illustrated example, the user devices communicate with a server 144 through one or both of the first wireless communications station 140 or the second wireless communications station 142. In various examples the server 144 is able to consist of a server, any suitable cloud computing infrastructure, or combinations of these.

The server 144 in an example is a cloud computing platform that includes functions to perform lifecycle management of apps on the user devices used by each of the four users depicted in the geographic environment 100. These apps in an example are able to include apps that allow the user to receive information relevant to the stores, retail businesses, or other consumer based businesses that likely to be of interest to the particular user of the respective user devices. In an example, the server 144 operates to install, manage operations of, support operations of, uninstall, perform other lifecycle maintenance for, or combinations of these, the apps on user devices associated with each of the depicted users.

The server 114 in some examples further interacts with a social context database 146. In various examples, the social context database 146 stores data related to each user's social contacts. In an example, the social context database 146 includes data based on social network interactions between users, stores observed interactions and shared activities between or among multiple users, other social related data, or combinations of these.

The sever 144 in an example also exchanges data with a user information database 148. The user information database 148 in some examples stores data associated with each user. Examples of information stored in the user information database 148 includes profile information for the user, such as preferences in various area, home and work locations, hobbies and interests, personal schedule information for each user, other profile information, or combinations of these. The user information database 148 in some examples is also able to store observations of each user's activities over time, such as purchasing histories, athletic practices and exercise, various activities, other information, or combinations of these. For example, two or more people engaging in a similar activity at the same time in the same place may be inferred to be social contacts. Such an inference is able to be strengthen by noting that such people are members of common groups, are associated in some way through a social media platform, by observing other connections, or combinations of these. In some examples, combining the information in the user information database 148 with the location of the user device used by that user is part of the device context of the user device.

In some examples, the server 144 is able to access and integrate data retrieved from the user information database 148 and social context data base 146 for all users with user devices in contact with the server to determine pairs or groups of users whose activities are relevant to each other. Based upon these identified pairs and groups and their activities, the serer 144 in some examples is able to determine and provide groups of icons for server based apps to the user devices of each user, and modify, such as by removing or adding icons, to that group of icons for server based apps based on changes in the observed activities of each user.

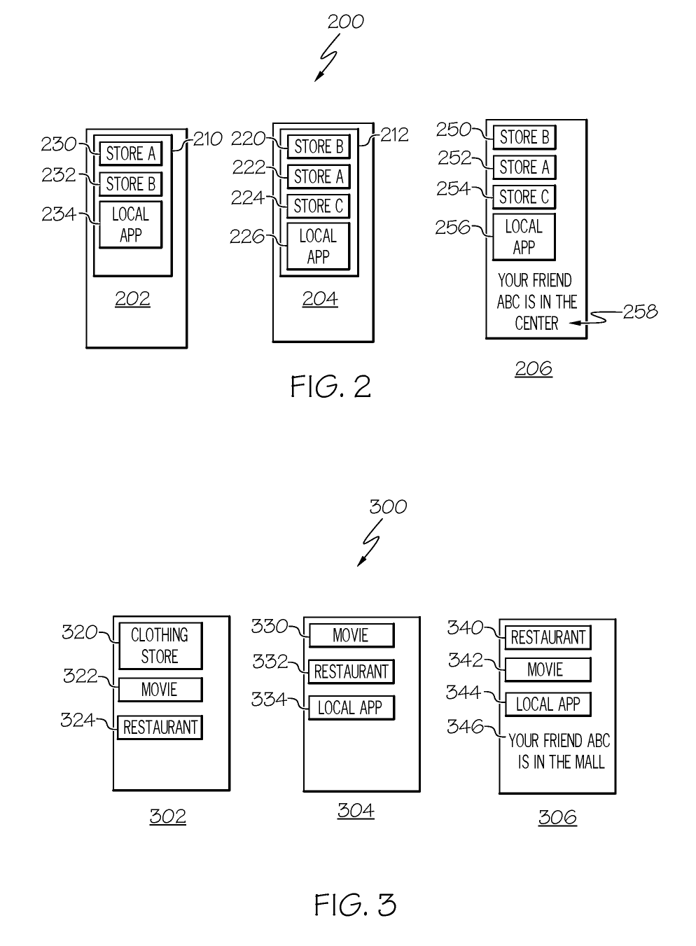

FIG. 2 illustrates shopping center area user device displays 200, according to an example. The shopping center area user device displays 200 illustrates displays that are able to be presented to the first user 110 and the second user 112 who are in the shopping center 102 as described above with regards to the geographic environment 100. The shopping center area user device displays depict a first display 202 that is initially presented on a first display screen 210 to the first user 110 and a second display 204 that is initially presented on a second display screen 212 to the second user 112. The first display 202 and the second display 204 in this example are presented in this example before a determination is made that these two people are close enough to each to modify the presented icons for server based apps based on their social context. The icons presented to the respective users in the first display 202 and the second display 204 are based on the individual interests and context for each user without being affected by the activities of the other user who is a social contact.

The first display 202 shows example icons displayed on a display of the device of the first user 110 when that user is in the location in the shopping center 102 shown in FIG. 1. The second display 204 shows example icons displayed on a display of the device of the second user 112 that user is in the location in the shopping center 102 shown in FIG. 1. The first display 202 and the second display 204 each depict a display of app icons for apps where some of those icons have been selected to be displayed on the respective devices based on a context determined for that device, which is assumed to be a context associated with the user of that device. As discussed above, the context of a device is able to include the device context of the device and the social context of the user of the device.

The depicted icons are examples of user interface elements associated with apps that are able to be used in conjunction with the user device. The icons illustrated in the two example shopping center area user device displays 200 include two types of icons, virtual icons and local icons. Virtual icons in one example include user interface elements that are associated with and that therefore represent sever based apps. A user is able to use a server based app in one example by selecting the virtual icon associated with the selected app. The selection of an icon is able to be made by any suitable technique, such as by touching a touch sensitive screen in the vicinity of the display of the icon. Examples of server based apps include cloud based apps that operate by at least partially performing some functions on a remote processor, and those functions are able to interact with user interfaces that are presented on the user device.

Virtual icons in one example are able to be managed by a virtual icon manager that operates on a remote server. In an example, the virtual icon manager is implemented by processing performed within a cloud computing infrastructure. The virtual icon manager in some examples is able to add icons to the display of a user device, determine positions at which to place each icon on the display of the user device, control operation of server based apps and the interaction with user interfaces operating on the user device, remove virtual icons from the display of the user device, or combinations of these. In some examples, the virtual icon manager is able to manage the lifecycle of server based apps on contexts associated with the user device or the user, where those server based apps are represented by virtual icons provided by to the user device by the virtual icon manager.

In addition to the virtual icons, the two example shopping center area user device displays 200 depict user device displays that include local app icons. Local app icons in an example are icons associated with apps that are installed on the user device and which primarily execute on the user device. In some examples, local icon apps are associated with apps that include apps installed under the control of the user of the device. The local app icons are examples of app interface indicators for installed local apps on the user device and that execute on the user device.

The first display 202 includes two virtual icons that were selected based on the context of the device used by the first user 110. As described above, the first user 110 is in the vicinity of Store A 120, and also near Store B 122. As shown in FIG. 1, Store C 124 is further from the first user 110 at that time. Because the first user 110 is closest to Store A 120 and Store B 122 and is further from store C 124, the first display 202 has a first icon 230 that is associated with a server based app for Store A 120 and a second icon 232 that is associated with a server based app for store B 122. In addition to using the device's context to select which icons to display on the first display, the locations on the user device display of these icons is also determined based on the context of the user device. For example, the first icon 230 representing a server based app for Store A 120 is placed above the second icon 232 representing a server based app for store B 122 because the user is located closer to Store A 120 than Store B 122. In the illustrated example, the two virtual app icons are placed above a first local app icon 234, although any other placement and arrangement is able to be determined by the remote server.

The second display 204 includes three virtual icons that were selected based on the context of the device used by the second user 112 and also based upon determined preferences of the second user 112. As described above, the second user 112 is in the vicinity of Store B 122, and also near Store C 124. As shown in FIG. 1, Store A 120 is further from the second user 112 at that time. In addition to the physical location information in this example, purchase histories of the second user 112 indicates that the second user often makes purchases in both store A and store B 122, but rarely makes purchases in store C 124. Because the second user 112 is closest to Store B 122 and has a history of making purchases in store B 122, the second display 204 has a third icon 220 that is associated with a server based app for Store B 122. Because the second user 112 has a history of making purchases from store A 120 and a weaker history of patronizing store C 124, the second display 204 has a fourth icon 222 that is associated with a server based app for store A 120. Below the third icon 220 and the fourth icon 222, a third icon 224 that is associated with a server based app for store A is position below the other two virtual app icons. In this example, an icon associated with store A 120 is positioned above an icon associated with store C 124 due to the user's apparent interest in store A 120 over store C 124, even though the second user 112 is closer to store C 124 than store A 120.

In addition to using the device's context to select which icons to display on the first display, the locations on the user device display of these icons is also determined based on the context of the user device. For example, the third icon 220 representing a server based app for Store C 124 is placed above on the fourth icon 222 representing a server based app for store B 122 because the user is located closer to Store C 124 than Store B 122. In the illustrated example, the two virtual app icons are placed above a second local app icon 226, although any other placement and arrangement is able to be determined by the remote server.

In addition to the first display 202 and the second display 204 the shopping center area user device displays 200 further include a first social context display 206. The first social context display 206 is an example of a display that is able to be presented on the devices of either or both the first user 110 and the second user 112 when they are sufficiently close enough to each other in the shopping center 102 that the server 144 determines that the icons presented to one or both of those people should be modified based on the activities, such as proximity, of the other's social contact. In various examples, the first social context display 206 is able to be presented to just one of the people, displays with similar content are able to be displayed to both people, or combinations of these.

The first social context display 206 includes three virtual icons that were selected based on the context of the user devices, preferences the user, the user's social contact whose activities are currently relevant to the user, on activities of users and their nearby social contact, or combinations of these. The virtual icons on the first social context display are selected in some examples also based upon determined preferences of the second user 112. As described above, the second user 112 is in the vicinity of Store B 122 and has made purchases there and also in Store A 120. In addition to the physical location information in this example, purchase histories of the second user 112 indicates that the second user often makes purchases in both store A and store B 122, but rarely makes purchases in store C 124. In this example, there is no purchase history or other preference indicators for the first user 110 with respect to these stores. Because the second user 112 is closest to Store B 122 and has a history of making purchases in store B 122, the second display 204 has a third icon 220 that is associated with a server based app for Store B 122. Because the second user 112 has a history of making purchases from store A 120 and a weaker history of patronizing store C 124, the first social context display 206 has a fourth icon 222 that is associated with a server based app for store A 120. Below the third icon 220 and the fourth icon 222, a third icon 224 that is associated with a server based app for store A is position below the other two virtual app icons. In this example, an icon associated with store A 120 is positioned above an icon associated with store C 124 due to the user's apparent interest in store A 120 over store C 124, even though the second user 112 is closer to store C 124 than store A 120.

The first social context display 206 also includes a notification 258 indicating that a social contact is in the shopping center. The notification 258 is able to be presented to both users, or to just one user, where the notification indicates the other person, whose name is represented as “ABC” in this example, that is nearby. Such a notification may also indicate that the displayed icons are related to shared interests between these two people to help the users determine activities they might both enjoy, such as shopping in store B 122.

FIG. 3 illustrates example mall area user device displays 300, according to an example. The example mall area user device displays 300 depict a third display 302 and a fourth display 304. The third display 302 shows example icons displayed on a display of the device of the third user 114 when that user is in the location in the mall 104 shown in FIG. 1, which is in the clothing store 130. The fourth display 304 shows example icons displayed on a display of the device of the fourth user 116 when that user is in the location of the mall 104 shown in FIG. 1, which is just entering the shopping area and moving towards the restaurant 134. The third display 302 and the fourth display 304 in this example each depict a display of app icons for server based apps where at least some of those icons have been selected to be displayed on the respective devices based on a context determined for that device, which is assumed to be a context associated with the user of that device, as well as based on preferences of the user. In this illustrated example, the third display 302 and the fourth display 304 are presented to the user of each respective device before a determination is made that an activity of a social contact of the user should affect the icons presented to the user

The function and operation of the icons displayed in the example mall area user device displays 300 are similar to those discussed above with regards to the example shopping center area user device displays 200. For example the mall area user device displays 300 include virtual icons, which represent server based apps, and local icons that represent apps locally installed on the device. As is discussed above, the virtual icons in some examples are able to be managed by the above described virtual icon manager.

The third display 302 includes three virtual icons that were selected based on the context of the device used by the third user 114. As described above, the third user 114 is in the clothing store 130 and near the movie 132. The selection of and the positional ordering of these three virtual icons is based on the location of the third user 114 relative to stores in the mall. Because the third user 114 is in the clothing store, the third display first virtual icon 320 is for a server based app for the clothing store 130. Presenting an icon for a server based app for the clothing store that the third user 114 is in allows the user to find out information about that store. Placing this icon at the top of the display calls the user's attention to this icon and encourages the user to select that icon and use the associated server based app.

Selected to be displayed and positioned below the top icon is a third display second virtual icon 322 that is associated with a server based app for the movie theater 132. Presenting an icon for a movie theater near the third user's location encourages the user to use the associated server based app and see if he or she is interested in any movies playing there.

The third display 302 also includes a third display third virtual icon 324 located below the other two virtual icons. Because the third user 114 is furthest from the restaurant 134, a third display third virtual icon 324 is displayed in this example at the bottom of the third display 302 where the third display third virtual icon 324 is associated with a server based app associated with the restaurant 134. The virtual icon for the restaurant 134 is shown at the bottom of the virtual icons because it is determined in this example to be of less interest to the third user 114 given the third user's location relative to the location of the restaurant 134. In further examples, a virtual icon associated with the restaurant may be placed more prominently on a display based on other factors, such as the display being presented near a customary meal time for the third user, based on a preference of the third user for the particular restaurant 134 or a chain of restaurants to which restaurant 134 may belong, based on other factors, or combinations of these.

The fourth display 304 includes two virtual icons that were selected based on the context of the device used by the fourth user 116. As described above, the fourth user 116 is entering the mall 104 and moving towards the restaurant 134. In addition to the context of the user device, additional information such as information related to the user or to the social context of the user of the user device is used in this example to determine the set of virtual icons and their display locations on the fourth display 304. In this example, it has been observed during past visits to the mall 104 by the fourth user 116 that the fourth user 116 usually goes to the movie 132 when entering the mall 104 alone, and less frequently goes to the restaurant 134 but is more likely to go to the restaurant 134 when entering the mall from the entrance that the fourth user 116 is currently using. Locations less likely to be of interest when meeting friends, such as clothing store 130, are given less priority in selecting virtual icons to present to the user and in this case are not presented at all.

The fourth display 304 has a fourth display first virtual icon 330 that is an icon associated with an app for the movie 132. Below that is a fourth display second virtual icon 332 that is an icon associated with a server based app for the restaurant 134. As described above, this selection and ordering is based on observed past behaviors of the fourth user 116.

The example mall area user device displays 300 further includes a second social context display 306 that is presented to both the third user 114 and the fourth user 116 in this example when it is determined that the icons for server based apps should be modified based on the activities of each user's social contacts. In this example, the third user 114 and the fourth user are social contacts with each other, and a notification 346 is presented to each informing the user that their friend is in the mall. Although one second social context display 306 is shown to reduce the complexity of the explanation of features of this example, the name ABC of the friend in the display for each user reflects the name of the other person. The second social context display 306 shows two virtual icons for server based apps that are selected based upon the common interests of the third user 114 and the fourth user 116. In this case, the observed history and preference lists for the third user 114 indicates that the third user 114 has a preference for the restaurant 134 and does not often go to movies. The observed history and preference lists for the forth user 116 indicates that the fourth user 116 also has a preference for the restaurant 134, but does enjoy movies. In this example, the second social context display 306 is presented to both users, but in further examples each user is able to have different icons or versions of server based apps. For example, if the profile information for these users indicates the third user 114 is a vegetarian and the fourth user 116 is non-vegitarian, the second social context first icon 340 presented to the third user 114 is able to be for a server based app for restaurant 134 that emphasizes vegetarian meals, while that icon presented to the fourth user 116 is able to be for a server based app that emphasizes non-vegetarian meals.

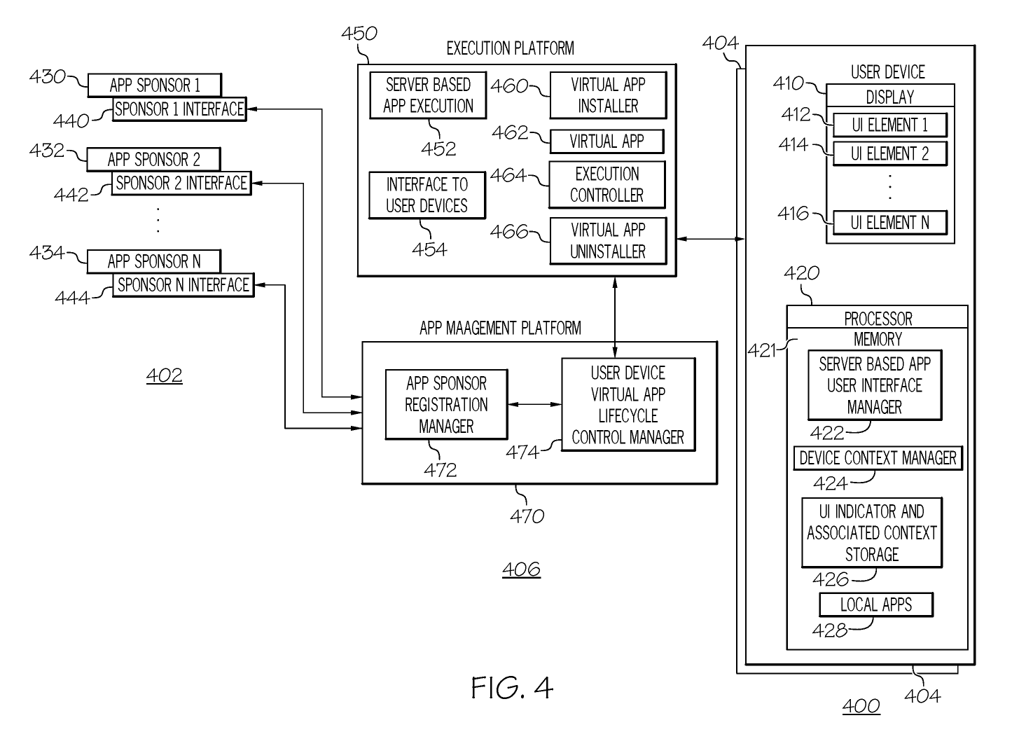

FIG. 4 illustrates a cloud based app management and deployment environment 400, according to an environment. The illustrated cloud based app management and deployment environment 400 depicts three fundamental components, a sponsor component 402, a cloud infrastructure component 406, and user devices 404. As described below, these components interact with each other to deliver and maintain a relevant set of virtual icons on a user device based on the user's profiles, activities of the user's social contacts, other information, or combinations of these, to allow the user to use server based apps that are relevant to the context of the user.

The sponsor component 402 includes a number of app sponsors, such as app sponsor 1 430, app sponsor 2 432, and app sponsor N 434. These app sponsors in some examples include operators of retail and other businesses, such as are discussed above in FIG. 1. For example, the operators of the stores in the shopping center 102 and the shops, stores, movies and restaurants in the mall 104 are each able to individually control one or more apps associated with a business that a user is able to use to receive information from, or otherwise interact with, that particular business.

Each app sponsor has a corresponding sponsor interface, such as the sponsor 1 interface 440, sponsor 2 interface 442, and sponsor N interface 444. These interfaces in one example include a cloud computing platform interface, such as an Internet Web browser or other computer communications program. In an example, one or more centrally located terminals or other user interface devices are able to be located in the vicinity of several sponsors, such as in an office of the shopping center 102 or a management office for the mall 104. These interfaces in an example allow a user, such as a person working for the particular app sponsor, to provide information to, and otherwise control or interact with, the cloud based computing platform that operates to provide certain cloud based apps deployed to the user devices 404. In an example, the app sponsors are able to dynamically register or unregister one or more server based apps to enable or disable to server based app to be available for deployment to devices in the user devices 404, otherwise configure, or control the server based app to present desired information, perform desired processing, or otherwise configure the server based app, or otherwise control the server based app's operation and deployment to user devices.

The user devices 404 include multiple user devices, such as the illustrated user devices 404. The user devices 404 are representative of any suitable user device, such as a smart phone, personal digital assistant (PDA), other devices used by individuals, or any other suitable device. The user devices 404 include a display 410 on which data, images, text, other visual information, or combinations of these, are presented. The illustrated display 410 includes a User Interface (UI) element 1 412, UI element 2 414, and a UI element N 416. In an example, these UI elements are icons presented on the display 410 of a user device in the user devices 404. Each of these UI elements, such as each icon, is associated with a particular app that is available for use by the user of a user device within the user devices 404. In an example, the display 410 is a touch sensitive display that allows a user to provide input by touching particular areas of the display 410. In an example with a touch sensitive display, a user is able to initiate operation of an app by touching, or otherwise selecting, a particular UI element on a touch sensitive display and an app associated with that UI element will start and provide a corresponding user interface to the user to use that selected app. In various examples, the UI elements are able to be associated with local apps, which have at least one component installed on the user devices 404, or server based apps that include processing operating on a cloud based server and that interact with user interface elements provided on the user devices 404.

The user devices 404 of one example include a processor 420 and memory 421. The processor 420 executes programs defined by applications stored in the memory 421. In an example, the memory 421 is able to store data defining programs or apps such as a server based app user interface manager 422, a device context manager 424, and one or more local apps 428. The server based app user interface manager 422 is an executable program in some examples that controls the display of virtual icons associated with server based apps on the display 410. The device context manager 424 in one example monitors indications of the user device context and reports relevant information regarding the present user device context to the cloud infrastructure component 406. Additionally, the memory 421 is able to store one or more local apps 428 that are apps executed by the processor 420 of the user device.

The memory 421 further includes a user interface indicators, locations and associated context storage 426. The user interface indicators, locations and associated context storage 426 in one example, stores a number of user interface indicators, such as icons, for virtual apps that correspond to server based apps. In addition to user interface indicators for one or more server based apps, the user interface indicators, locations and associated context storage 426 in some examples stores locations at which those user interface indicators, such as icons, are to be displayed on the display 410. Additionally, the user interface indicators, locations and associated context storage 426 is able to store specifications of the user devices contexts in which certain server based apps are to be displayed on the display 410. For example, a particular server based app is able to specify that its icon is to be displayed when the user device is within a specified geographic location.

The cloud infrastructure component 406 includes an app management platform 470 and an execution platform 450. The app management platform 470 and the execution platform 450 in an example are provided on a cloud based infrastructure that allows the virtual access of all of their functions via a suitable communications network. Although the app management platform 470 and the execution platform 450 are each shown as one element that are in communications with one another, the actual realization of these function is sable to have any structure in a cloud computing infrastructure.

The app management platform 470 includes an app sponsor registration manager 472. The app sponsor registration manager 472 interacts with app sponsors within the app sponsor component 402, such as via the sponsor interfaces described above, to configure the server based apps for deployment to and use on the user devices 404. In an example, the app sponsor registration manager 472 allows a sponsor of a server based app, such as a store owner or other promoter of a business, to register or unregister one or more of that sponsor's server based app in order to enable or disable one or more of that sponsor's server based app to be available to client devices. In an example, the app sponsor registration manager 472 allows app sponsors to setup installers and uninstallers to install or uninstall the sponsor's server based apps onto user devices. The app sponsor registration manager 472 in some examples further allows an app sponsor to upload, configure, otherwise manipulate, or combinations of these, the server based apps that are provided through, and that execute on, the cloud based infrastructure for use by users, such as via a user interface provided on the user devices 404. In some examples, the app sponsor registration manager 472 allows the app sponsor to specify device context related conditions that control when a User Interface element, such as an icon, associated with a particular server based app is to be loaded onto or removed from a particular user device within the user devices 404.

The app management platform 470 further includes a user device virtual app lifecycle control manager 474. The user device virtual app lifecycle control manager 474 controls the user interface elements provided to, removed from, otherwise altered or manipulated, or combinations of these, from the user devices 404. In an example, the app lifecycle control manager 474 invokes install and uninstall scripts to install or remove user interface elements, such as icons, onto the user device for selected server based apps. In some examples, the app lifecycle control manager 474 also loads or removes appropriate parameters for each installed or uninstalled user interface element, such as parameters for installing a representation of the server based app, transferring an icon image and information used to identify the server based app as part of the installation process of the virtual app onto the user device.

In some examples, the app lifecycle control manager 474 further monitors context related information for each user device, and determines which user devices satisfy context related conditions specified for installation of, removal of, modification of, other modifications of, or combinations of these, one or more server based apps. As discussed above, an app sponsor is able to specify context related conditions cause a virtual app to be installed on to a user device when the context of that user device satisfies those specified conditions. In one example, the app lifecycle control manager 474 receives various data from the app sponsor registration manager 472 to define server based apps to deploy to various user devices, to define the associated contexts in which to deploy certain server based apps, to specify other operational information, or combinations of these. The app management platform 470 in one example receives app related information and data such as the above described information and data provided by the app sponsors from the app sponsor registration manager 472.

In addition to, or in place of, conditions specified by an app sponsor, other device context related conditions are able to be specified by any suitable source. For example, context related conditions are able to be based on fixed geographical locations. In an example, the app lifecycle control manager 474 is able to be configured with one or more geographic locations associated with each server based app where the geographic locations correspond to a geographic vicinity near each store or other facility that is associated with the server based app. In such an example, each user device reports its present location to the app lifecycle control manager 474. The app lifecycle control manager 474 then compares the present context of each user device with the device context conditions specified for each server based app. When the present device context of a user device satisfies the context specification for a server based app, and also satisfies any other context based conditions for that server based app, the app lifecycle control manager 474 then operates to cause a user interface element to be installed onto the user device for the server based app whose context related conditions have been satisfied.

In addition to device context information, such as location, environmental information, usage status of the device, other information, or combinations of these, the app lifecycle control manager 474 is able to determine icons for server based apps to present to a user based on the social context of the that user. For example, the app lifecycle control manager 474 is able to base determining icons and their display location based on interests or activities of one or more of that user's social contacts. As is described in further detail below, the app lifecycle control manager 474 is able to include processing based on the social context of the user that includes data associated with a user's social contacts to determine icons to present to the user.

The execution platform 450 in one example includes the cloud based components that manage and support the operation and deployment of server based apps, also referred to as virtual apps, in conjunction with user devices 404. The execution platform 450 includes a virtual app storage 462 that stores executable software executed within the cloud based infrastructure to perform the functions provided by server based apps. The execution platform further includes a virtual app installer 460 that manages the installation of virtual apps onto user devices. In an example, installation of a particular virtual app onto a user device includes sending a definition of an icon associated with the particular server based virtual app to the user device, along with information identifying the server based app that allows the user device to exchange information with and otherwise inter-operate with the server based app executing on the cloud based infrastructure. The execution platform 450 further includes a virtual app uninstaller 466 that manages de-installation of virtual apps from user devices. In an example, the virtual app uninstaller 466 communicates with the user device to cause icons for apps to be removed when the context specifications for those apps are no longer satisfied by the context of the user device.

The execution platform 450 includes a server based app execution component 452. The server based app execution component 452 implements the processing to perform the functions of the server based apps supported by the cloud infrastructure component 406. The server based app election component 452 in an example operates with an interface to user devices 454 to exchange user interface data with the user interfaces provided on the user devices 404 with which each server based app executing via the server based app execution component 452.

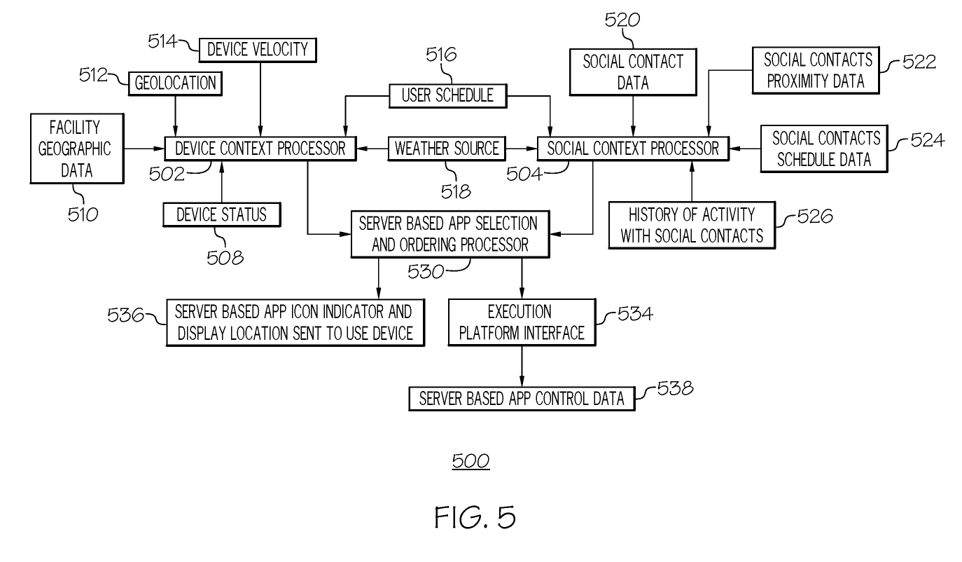

FIG. 5 illustrates a user context processing block diagram 500, according to an example. The user context processing block diagram 500 in some examples reflects processing performed by the user device virtual app lifecycle control manager 474 described above. The user context processing block diagram 500 depicts processing that operates to determine and process both device context for the user device and also the social context of the user of the user device based on any suitable set of factors, including activities of the user and the user's social contacts.

The user context processing block diagram 500 includes a device context processor 502 and a social context processor 504. These processors receive data, observations, other information, or combinations of these, in order to support selection of server based apps whose icons are to be provided to a user device for display to the user. In some examples, these processors further determine locations for placing these apps on a display presented to the user.

The device context processor 502 in one example receives data from multiple sources to determine or infer device contexts for the user device, and thus context information relating to the user. In the illustrated example, the device context processor 502 receives device status information from a device status element 508. Device status in some examples includes any data related to the status of the device, such as one or more of locomotive state of the device, current usage status of the device such as whether the device is in active use (such as in a call, being used for data operations, other uses, or combinations of these), availability of resource on the device, such as remaining power source capacity, data communications rates, memory availability, availability of any other resource of the device, or combinations of these.

The device context processor 502 in the illustrated example further receives device geolocation information from a geolocation source 512 and device velocity from a device velocity source 514. In various examples, device geolocation and velocity are able to be determined by the device and reported via the above described device status element 508 to a processor implementing the device context processor 502. In further examples, one or both of device geolocation or velocity are able to be determined by any suitable techniques such as triangulation from cellular phone towers, observation of the user, other techniques, or combinations of these.

The device context processor 502 further receives facility geographic data from a facility geographic data source 510. In an example such as that described above with regards to FIG. 1, the facility geographic data sources 510 is able to have information of the physical layout of the shopping center 102 or the mall 104. Such information is able to be used with the location of the user device in those examples to determine stores or other facilities that are physically close to the user, and therefor convenient for the user to visit.

The device context processor 502 in some examples is able to receive information about a user's schedule from a user schedule source 516. The user's schedule information is able to be used to, for example, help determine the present or future activities for the user. Weather information is able to be received from a weather information source 518. Weather information, such as temperature, rain, snow, other weather information, or combinations of these, are able to be used to determine or better approximate interests of the user at the time, such as interests in types of clothing to purchase, types of outdoor activities to participate in, types of food or beverages to buy, other interests, or combinations of these.

The social context processor 504 in some examples operates to determine, estimate, predict, or combinations of these, activities of a user of a user device. In some examples, the social context processor 504 receives information from various sources, such as current or predicted environmental conditions, activities of social contacts of the user, proximity of social contacts to the user, histories of observed behavior of the user in various situations, other information, or combinations of these.

In an example, the social context processor 504 receives user schedule information from the user schedule source 516 and weather information from a weather source 518, such as those described above. The social context processor 504 in an example further receives social contact data from a social contact data source 520. Social contact data includes any type of data about people who are social contacts of the user of the user device. Social contact data in some examples includes interests, activities, other information, or combinations of these, of people who are social contacts of the user. In an example, social networking systems, other information sources about contacts of a person, other sources, or combination of these are able to act as a social contact data source 520.

The social context processor 504 receives social contact proximity data from a social contact proximity data source 522. Social contact proximity data is able to be provided by any suitable source, such as by location data of devices owned by persons who are social contacts of a user. The social context processor 504 receives social contact schedule data from a social contact schedule data source 524. Social contact schedule data is able to be provided by any suitable source, such as by a central calendaring application, schedule data stored in association with persons who are social contacts of the user, other sources, or combinations of these.

The social context processor 504 receives histories that describe activities that a user of a user device has been observed in with persons who are social contacts. For example, patterns of meeting certain people who are social contacts for meals, sporting events, certain types of events, other activities, or combinations of these are able to be observed and stored in a history of activity with social contacts 526. The history of activity with social contacts 526 in some examples is able to store determined or likely activities that a user participates in with others who are social contacts along with identifications of those persons.

The user context processing block diagram 500 includes a server based app selection and ordering processor 530. The server based app selection and ordering process 530 determines a set of selected server based apps whose icons are to be presented to a user. The set of selected server based apps whose icons are to be presented is determined in some examples based upon data provided by the device context processor 502 and the social context processor 504. In an example, the set of selected server based apps is a subset of all of the server based apps available from the server.

The server based app selection and ordering process 530 sends to the user device indications of the determined server based app icons and display locations of those icons. The server based app selection and ordering process 530 further sends information to control the operation of the server based app itself to an execution platform interface 534. This server based app control data 538 is then provided to the execution platform 450, which is described above with regards to FIG. 4.

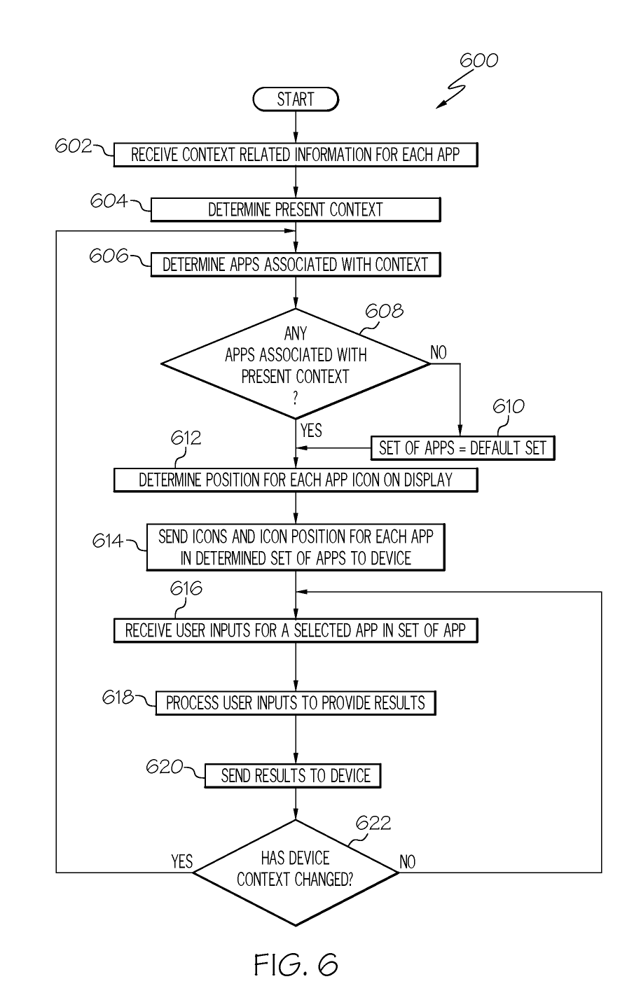

FIG. 6 illustrates a present context app management platform process 600, according to an example. The present context app management platform process 600 illustrates an example process flow performed by a cloud infrastructure component 406 as discussed above. The illustrated present context app management platform process 600 receives information from a user device that conveys the present context of the user device. Based on that present context, the present context app management platform process 600 determines selected virtual apps to be presented to the user of the user device, conveys icons for those selected virtual apps to the user device, and supports operation of those selected virtual apps by performing the processing associated with each of the selected virtual apps the user of the user device is using. In an example, the present context includes not only a location of the user device, but other information related to the device context such as ambient temperature, speed and direction of movement, device usage status, resource availability, other information, or combinations of In addition to device context information, the context information is also able to include social context information for the user of the user device. In an example, the present context app management platform process 600 is performed on a cloud based infrastructure and interacts with user interface elements provided on the user device. In general, many instances of the illustrated present context app management platform process 600 are able to operate to support many user devices or multiple virtual apps operating contemporaneously on a particular user device.

The present context app management platform process 600 begins by receiving, at 602, context related information for each server based app. In an example, this context related information is received from the sponsor of each server based app. In general, each server based app is able to have an associated specification of context related conditions that define the contexts in which an icon for that app is to be presented and generally control when the server based app is presented to a user of a user device.

The present context app management platform process 600 continues by determining, at 604, a present context. The present context in some examples is able to include both device context for the user device and social context for the user of the user device. This present context in one example is determined at least in part based upon context related information that is determined and reported by a user device. The context related information in other examples are able to be determined, reported, or both, by any suitable technique either operating on the user device or by monitoring or information sources that are separate from the user device. In an example, the present context is a context at a first timepoint that is sufficiently close to the present time such that the reported context is relevant to the user of the user device.

The present context in an example is determined by assembling the received context related information into a form to facilitate comparison to specified context related conditions for each app. In an example, determining the context is able to be based on any context status associated with the user device or the user, such as the user device location, user device movement, user device communications status, user device communications history, social media contacts for a user of the user device, social media activities of a user of the user device, physiological information of a user associated with the user device, calendar entries for a user of the user device, preferences of a user of the user device, or information within a profile of a user of the user device, determined or predicted activities of the user, other context related information as discussed herein, or combinations of these.

The present context app management platform process 600 determines, at 606, a set of server based apps that are associated with the determined present context for the user device. This determination in an example is based upon a comparison of the received context related information for each server based app and the determined present context of a user device.

A determination is then made, at 608, if any server based apps are determined to be associated with the determined present context of the user device. In an example, server based apps are associated with the determined present context of the user device when the received context related information matches the context related conditions specified for the server based app.

If it is determined that there are no server based apps associated with the present context, the set of server based apps is set to a default set of server based apps, at 610. In an example, the default set of server based apps is defined to be no server based apps. In further examples, the default set of server based apps is defined to be a set of server based apps that are considered to be of general interest to users regardless of the context of the user device.

After determining the set of server based apps as either server based apps associated with the present context or as a default set, the present context app management platform process 600 determines, at 612, a position in the display to be presented on the user device for each virtual icon associated with each server based app in the determined set of server based apps. The determined position is able to be specified as positions relative to other virtual icons, relative to other virtual icons and local app icons, as positions relative to local app icons, as absolute locations on the display, as any suitable location specification, or as any combination of these. In an example, the respective display locations for each virtual icon is able to include locations within a plurality of local app icons, which are app interface indicators for installed local apps that are installed on the user device and that execute on the device.

Icons and a specification of the determined location on the display for each icon for each server based app within the set of server based apps are sent to the device, at 614. These icons are then displayed by the user device. A user of the user device is able to select an icon by any suitable technique, and begin access to a server based app associated with the icon selected by the user. In various examples, once a user selects an icon for a particular server based app, a user interface for the selected server based app is presented on the user device. This user interface for the selected server based app is able to be provided alone with the icon associated with that server based app, or the present context app management platform process 600 is able to send such user interface definitions based on receiving an indication of a user input selecting the icon.

The present context app management platform process 600 receives, at 616, user inputs for a selected app in the set of apps. In some examples, these user inputs are able to include an input to select an icon for a particular server based app as well as other user inputs to the user interface associated with the selected server based app. Based on these received user inputs, the present context app management platform process 600 processes the user inputs to produce results. These results are able to include, for example, a different user interface to present to the user on the display of the user device, information to be presented to the user on the user interface device, any other type of result, or combinations of these.

The present context app management platform process 600 sends, at 620, these results to the user device. In general, these results are presented to the user on a visual, audio, or other output device and are able to allow further inputs to be received from the user.

A determination is then made, at 622, if the context has changed. This determination is able to be based upon receiving context related information from the user device, receiving information from any other source, or combinations of these, as is discussed above with regards to determining the present context, at 604. The second user context in an example is able to include a device context and a social context. In an example, determining if the context has changed includes determining a second context of the user device at a second timepoint, where that second timepoint is subsequent to the first timepoint at which the context was determined, at 604.

If the context has not changed, the present context app management platform process 600 returns to receiving, at 616, user inputs as is described above. A change in context is able to be found in some examples if a change is detected in one or both of the device context for the user device and the social context of the user of the user device. If the context has changed, the present context app management platform process 600 returns to determining, at 606, server based apps that are associated with this new context and continues with the subsequent processing described above.

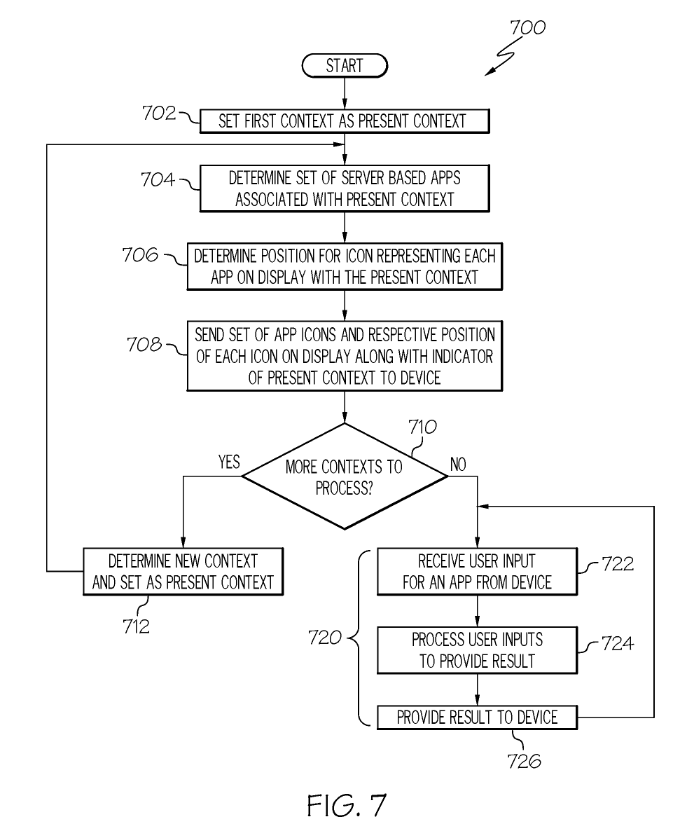

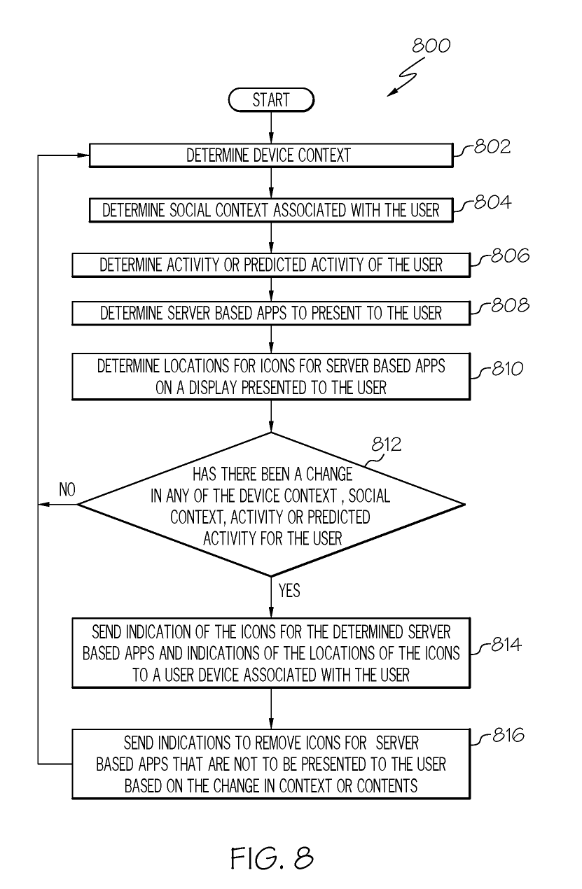

FIG. 7 illustrates a multiple device contexts app display definition process 700, according to an example. The multiple device contexts app display definition process 700 is similar to the present device context app management platform process 600 discussed above but determines multiple sets of server based apps, where each set of server based apps includes server based app icons and associated information for each of multiple device contexts. These multiple sets of server based apps are sent, along with a definition of each associated context, to the user device. This allows the user device to autonomously determine and present relevant virtual app icons based on the context of the user device as determined at the user device. These device contexts in an example are able to include both a device context of the user device and a social context of the user of the user device.

The multiple device contexts app display definition process 700 begins by setting, at 702, a first context as a present context. As discussed above, each server based app is able to have an associated specification of context related conditions that controls when the server based app is presented to a user of a user device. The multiple device contexts app display definition process 700 determines or defines sets of context related conditions for a number of server based apps for a number of defined contexts. In one example, theses sets of context related conditions for a number of server based apps are created at a time prior to sending those sets of context related conditions user devices. In this manner, the user device is able to compare stored sets of context related conditions and if the context related conditions of one of those sets is satisfied by a present context of that user device, icons for server based apps associated with the matched set of context related conditions can be displayed by the user devices 404 independent of interaction with the cloud infrastructure component 406.

The contexts defined by the multiple device contexts app display definition process 700 are able to be selected based on any suitable criteria. For example, in the above described example depicted in FIG. 1, a set of geographic locations within the shopping center 102 are able to be defined such that each context in the set of defined contexts corresponds to being near each store within the shopping center 102. In one example, setting this first context as a present context corresponds to determining a first context of a user device at a first timepoint. In this example, the first timepoint corresponds to a time in the future at which the user device will satisfy the conditions for this first context, and thus result in the display of associated icons, as is described below.

The multiple device contexts app display definition process 700 determines, at 704, a set of server based apps that are associated with the present context for the user device. The multiple device contexts app display definition process 700 determines, at 706, a position in the display to be presented on the user device for each virtual icon associated with each server based app in the determined set of server based apps. The determined position is able to be specified as positions relative to other virtual icons, relative to other virtual and local app icons, as positions relative to local app icons, as absolute locations on the display, as any suitable location specification, or as any combination of these.

Icons and a specification of the determined location on the display for each icon for each server based app within the set of server based apps are sent to the device, at 708. In general, these icons and associated data are stored on the user device and when the user device determines its context matches one of the determined contexts, the set of server based apps is then displayed to the user of the user device.

A determination is made as to whether more contexts are to be processed, at 710. If more contexts are to be processed, a new context is determined and set as the present context, at 712. In an example, this iteration of determining a new context is an example of determining a second context at a second timepoint that is after the first timepoint. In this example, the second timepoint is the timepoint at which the context of the user device satisfies the context conditions for a subsequently determined set of server based apps. If it is determined that no more contexts are to be processed, user inputs associated with a server based app are received and processed, at 720.

In an example, the multiple device contexts app display definition process 700 receives, at 722, user inputs for a selected app in the set of apps. In some examples, these user inputs are able to include an input to select an icon for a particular server based app as well as other user inputs to the user interface associated with the selected server based app. Based on these received user inputs, the multiple device contexts app display definition process 700 processes, at 724, the user inputs to produce results. These results are able to include, for example, a different user interface to present to the user on the display of the user device, information to be presented to the user on the user interface device, any other type of result, or combinations of these.

The multiple device contexts app display definition process 700 sends, at 726, these results to the user device. If the device context has not changed, the multiple device contexts app display definition process 700 returns to receiving, at 722, user inputs as is described above. It is noted that the user input reception and processing 720 in this example is performed independently of an indication of the context of the user device being provided to the server based app, or to the cloud infrastructure component 406 discussed above.

FIG. 8 illustrates a social context based icon determination process 800, according to an example. The social context based icon determination process 800 is similar to the above described present device context app management platform process 600 but includes the social context of the user of the device in determining which server based apps are to have icons displayed to a user and where to place those icons on the display. Examples of social context that are considered in the in the social context based icon determination process 800 include interests or activities of people who are social contacts of the user, interests or activities of people who are social contacts of the user and also in proximity to the user, any other data associated with social contacts of the user, or combinations of these. Information about social contacts is able to be obtained by any technique, such as information provided by a social network operator, information provided by devices associated with people who are social contacts of the user, by any other technique, or combinations of these. In this context, a social contact is a person who has some type of social connection with the user, such as being in a list of contacts associated with the user such as in a contact list on the user device or on another storage device, being associated in a social networking system or site with the user, having any other connection with the user, or combinations of these. In some examples, the social context of a user is determine based on identified commonalities between interests or activities of that user and social contacts of that user, social contacts that are in proximity to that user, or combinations of these.

In an example, the social context based icon determination process 800 is able to be performed by a cloud infrastructure component 406 as discussed above. The illustrated social context based icon determination process 800 receives information from a user device that conveys the present context of the user device. In an example, the present context includes not only a location of the user device, but other information such as ambient temperature, speed and direction of movement, other information such as is discussed above, or combinations of these. The social context based icon determination process 800 further receives information associated with a social context of the user of the device. In some examples, the social context based icon determination process 800 operates to estimate or predict expected activities that the user is engaged in, that he or she may do in the future, or at least be interested in. Based on the present device context, social context, and predicted activities, the social context based icon determination process 800 determines selected virtual apps to be presented to the user of the user device, conveys icons and sometimes display locations for those selected virtual apps to the user device, and supports operation of those selected virtual apps by performing the processing associated with each of the selected virtual apps the user of the user device is using.

The social context based icon determination process 800 begins by determining, at 802, the device context information for the user device. Device context information in various examples is able to include information such as the location and determined motion of the user device, an ambient temperature of the user device, usage status, resource availability, other information as is described above, or combinations of these. In general, the device context information is able to be received from the user device based on measurements made by the user device, or context information in various situations may be obtained by other techniques such as weather observations in the vicinity of the user obtained from any service or observer, inferred information based on other observations, other data, or combinations of these.

The social context based icon determination process 800 determines, at 804, a social context associated with the user of the user device. In various examples, the social context of a user is able to be based on activities of social contacts of the user of the user device, such as a determination that one or more people who are social contacts of the user are in the vicinity of the user, one or more people who are social contacts of the user are engaged in activities of interest to the user, other conditions, activities, or other characteristics associated with people who are social contacts of the user, or combinations of these.

The social context based icon determination process 800 determines, at 806, an activity or predicted activity of the user of the user device. Predicted activities are able to be determined by, for example, monitoring a location and movement of the user as reported by the user device or other techniques. For example, a user whose location is determined to be within a store and who is moving slowly and stopping frequently in the store may be determined to be shopping in that store. In another example, a user who is driving to a restaurant at a time of day when that person has been observed to normally eat may be a basis for predicting that the user will be eating. Other characteristics of a user's movement, location, other information, or combinations of these are able to be used as a basis of determining an activity or predicting an activity of the user.

The social context based icon determination process 800 determines, at 808, a set of server based apps that are associated with the present context of the device and the social context of the user. The social context based icon determination process 800 determines, at 810, a location in the display to be presented on the user device for each virtual icon associated with each server based app in the determined set of server based apps. The determined position is able to be specified as positions relative to other virtual icons, relative to other virtual and local app icons, as positions relative to local app icons, as absolute locations on the display, as any suitable location specification, or as any combination of these.

The social context based icon determination process 800 determines, at 814, if a change has been detected in any one or more of the device context, social context, activity of the user, or of predicted activities of the user. In the first iteration of the social context based icon determination process 800 in one example, there are not prior contexts to compare to so a change is assumed in such an instance. If there is not determined to be a change in any of these contexts, the social context based icon determination process 800 returns to determine, at 802, the device context as is described above, and continues with the above described subsequent processing.

If a change in context or activities is detected, at 812, indications of icons for the determined server based apps and, in some examples, indications of determined locations on the display for each icon for each server based app within the set of server based apps are sent to the device, at 814. In general, these icons and associated data are stored on the user device and when the user device determines its context matches one of the determined contexts, the set of server based apps is then displayed to the user of the user device. In some examples, descriptions of the icons and further information to support presentation of the icons for server based apps, along with user interface information to support interaction between server based apps and the user when a user selects an icon for a server based app, is able to be sent to the user device at this time.

The social context based icon determination process 800 in some examples sends, at 816, indications to remove icons for server based apps that are not to be presented to the user based on the determined change in context or contexts. As described above, icons for server based apps are able to have specified associated contexts of one type or another for a device or user of the device in order for that icon to be presented to the user of that device. When one or more contexts of the device or user of the device changes, the context related conditions for some icons that are being presented to the user may no longer be satisfied, and those icon are then removed from the display of the user device. The social context based icon determination process 800 then returns to determining, at 802, the device context as is described above and continues with the above described subsequent processing.

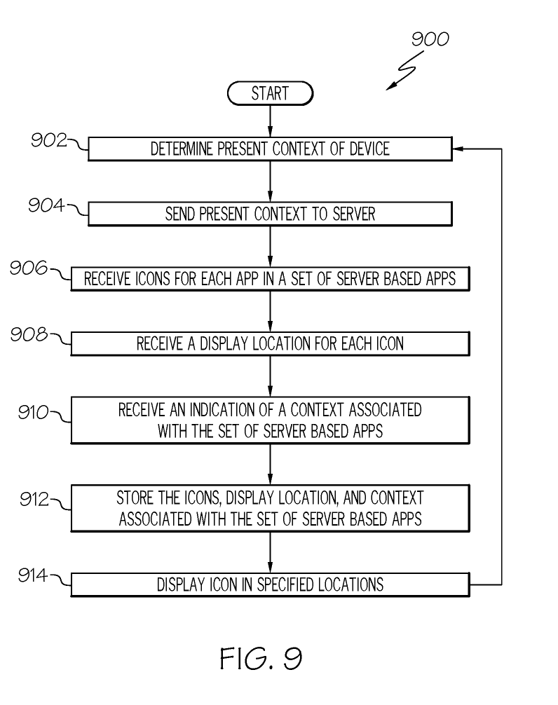

FIG. 9 illustrates a user device icon receipt process 900, according to an example. The user device icon receipt process 900 is an example of a process performed by a processor 420 within a user device within the user devices 404 as is described above. In an example, the user device icon receipt process 900 includes processing defined by the server based app user interface manager 422. The user device performing the user device icon receipt process 900 in some examples is able to be a mobile device, such as a mobile phone, cellular phone, cellular smart phone, other mobile device, any other suitable device, or combinations of these.

The user device icon receipt process 900 beings by determining, at 902, a present context of the user device. The present context is able to include, for in an example, both a device context of the user device and a social context of the user of the user device. Device context of the user device is able to include, for example, the present location of the user device, a speed and direction of movement of the user device, a state or history of voice communications (such as phone usage) of the user device, availability of resource on the device, preferences or other information stored within a profile of a user of the user device, activities of a user associated with the user device as determined by, for example, social circles and activities, physiological parameters of the user, calendar, other context parameters, or combinations of these. The social context of the user is able to be any social context as is descried above.

In some examples, the icon receipt process 900 iterates at various times. In an example, each iteration causes the determining a present device context to be an example of determining a new present user device context. In some examples the new present device context is able to include one or both of a new user device context and a new social context.

The user device icon receipt process 900 sends, at 904, in one example the determined present context to a server. In some examples, the server, such as within a cloud based infrastructure, is able to respond to the determined context of the user device and provide, modify, remove, or combinations of these, based on the present context of the user device as determined by the user device and reported to the cloud based infrastructure.

The user device icon receipt process 900 receives, at 906, icons for each app within a set of server based apps. In some example, these icons are examples of user interface elements that can be displayed to a user of the user device. In some examples, processing within a cloud based infrastructure determines which apps to include within the set of server based apps are selected based upon the present context of the user device. The processing within the cloud based infrastructure then sends icons for each app within the set of server based apps to the user device.

The user device icon receipt process 900 in some examples receives, at 908, a location for display each icon within the received icons for each app within the set of server based apps. The location at which to display each icon is able to be determined by processing within a cloud based infrastructure in order to, for example, place more relevant icons at the top of the display of virtual icons. In some examples, the location at which to display each of these virtual icons is able to be specified relative to local icons for locally installed aps on the user device so that virtual icons and local icons are able to be interleaved on the display presented to the user of the user device in order to cause the virtual icons to be within one or more local icons.

The user device icon receipt process 900 in some examples receives, at 910, an indication of a context associated with the set of server based apps for which associated icons were received. This indication of context allows processing within the user device to determine if the present context of the user device matches the context associated with the set of server based apps, and therefore the icons associated with the set of server based apps should be displayed on the display of the user device. In some examples, this indication of a context associated with the set of server based apps is able to include both device context definitions, and social context definitions.

The received icons, display location, and context associated with the set of server based apps are stored, at 912. Storing these data allows subsequent processing by the user device to determine if the user device enters a context that satisfies contexts for a set of server based apps. Upon such as determination, the user device is then able to retrieve and display the icons associated with the set of server based apps whose context conditions are satisfied by the device's context, such as is described below. Storing these context indications allows reducing the amount of data transmitted between the user device and the cloud computing infrastructure.

The user device icon receipt process 900 continues by displaying, at 914, the received icons for the server based apps in their specified locations. In some examples, icons for locally stored apps are able to be displayed along with the received icons for server based apps. After the icons are displayed, the user device icon receipt process 900 returns to determining, at 902, the present context of the device and the above described subsequent processing.

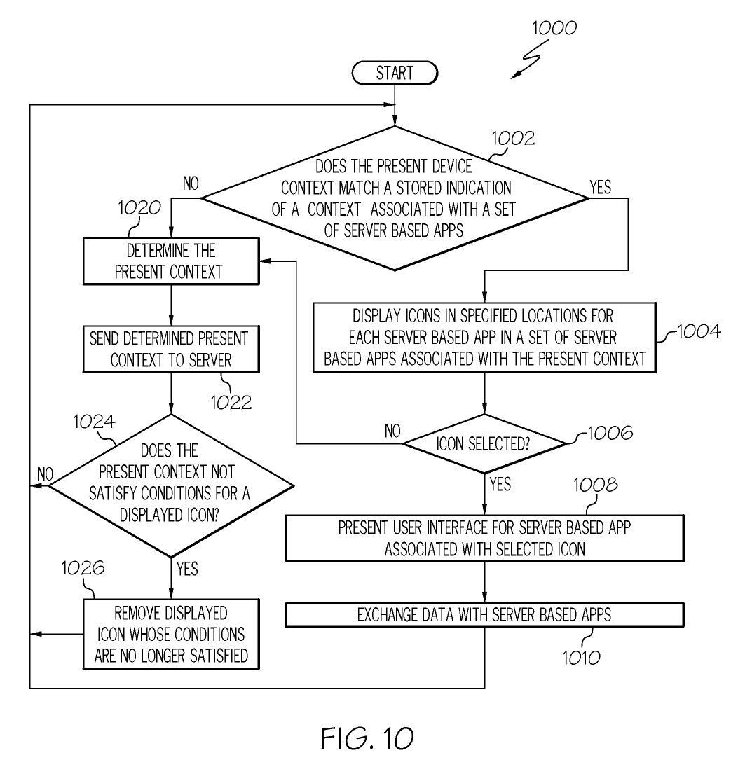

FIG. 10 illustrates a user device context adaptation process 1000, according to an example. The user device context adaptation process 1000 is an example of a process performed by a processor 420 within a user device within the user devices 404 as is described above. In an example, the user device context adaptation process 1000 includes processing defined by the server based app user interface manager 422. The user device performing the user device context adaptation process 1000 in some examples is able to be a mobile device, such as a mobile phone, cellular phone, cellular smart phone, other mobile device, any other suitable device, or combinations of these. In an example, the user device context adaptation process 1000 is performed after the user device receives one or more sets of icons for server based apps and indications of context for the sets of icons in order to determine which icons to display to the user.

The user device context adaptation process 1000 in some examples determines, at 1002, whether the present device context matches a stored indication of a context associated with a set of server based apps. In an example, the device is able to receive icons and associated indications of contexts as is described above with regards to the user device icon receipt process 900. The contexts in some examples are able to include both a device context and a social context as are described above. If such a match is not determined, the user device context adaptation process 1000 determines, at 1020, the present device context and returns to the determination, at 1002. In some examples, this newly determined present device context is an example of a new present user device context and is able to include one or both of a new user device context and a new social context for the user of the device. In some examples, the newly determined present device context is also sent, at 1022, to a server, as is described above. In some examples, a server receiving the new device context is able to send additional icons to the user device, at which point the user device will display those icons as described above.

In some examples, after determining the present device context, at 1020, or after sending the newly determined device context is sent to the server, a determination is made, at 1024, as to whether the present device context does not satisfy conditions for an icon that is displayed on the display of the user device. If the present device context does not satisfy conditions for an icon that is displayed on the display of the user device, that displayed icon whose conditions are no longer satisfied is removed, or uninstalled, at 1026 from the presentation on the user display. If it is determined that the present device context does satisfy conditions for the icons displayed on the user device display, or after icons whose conditions are no longer satisfied are removed or uninstalled, the user device context adaptation process 1000 returns to determining, at 1002, if the present device context matches a stored indication of a context, and performs the above described subsequent processing.

If it is determined, at 1002, that the present device context matches a stored indication of a context associated with a set of server based apps, the user device context adaptation process 1000 displays, at 1004, icons in specified location for each server based app in a set of server based apps associated with the present context. Once these icons are displayed, a user is able to select a server based app by selecting one of the displayed icons. In some examples, the display of icons for server based apps is able to be interleaved with icons for apps stored on the user device. The equipment used to display the icons in one example is able to be a display of a mobile device, such as a cellular telephone or smart phone. In some examples, the icons for the server based apps are displayed in a default pane of the display of the device. This default pane is able to also include icons for locally installed apps or other apps or functions able to be accessed or used by a user of the device displaying the icons.

A determination is made, at 1006, if an icon is selected. In an example, a user is able to select an icon by pressing a touch sensitive display of the user device in the vicinity of a display of the icon of the desired server based app. Such an icon selection in one example is able to be made by a single interaction, such as a single click, single touch, or single tap of the icon displayed on the user device. If it is determined that an icon is not selected, the user device context adaptation process 1000 determines, at 1016, if the present device context matches a stored indication of a context, and performs the above described subsequent processing.

If it is determined, at 1006, that an icon is selected, the user device context adaptation process 1000 presents, at 1008, a user interface for a server based app associated with the selected icon. In an example, the user interface for a selected server based app is able to be provided by the cloud based infrastructure, the user interface is able to be stored on the user device, or the user interface is able to be obtained through any suitable technique.

The user device context adaptation process 1000 then exchanges, at 1010, data with the selected server based app. In an example, the user interface provided by the user device accepts user inputs and forwards those inputs the selected server based app, such as an app operating on the execution platform 450 discussed above. The server based app is then able to determine results, either based on or independent of the user inputs, and provide those results to the user device for display to the user, such as via a user interface provided for that server based app on the user device. The user device context adaptation process 1000 then returns to determining, at 1002, if the present device context matches a stored indication of a context, and performs the above described subsequent processing.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

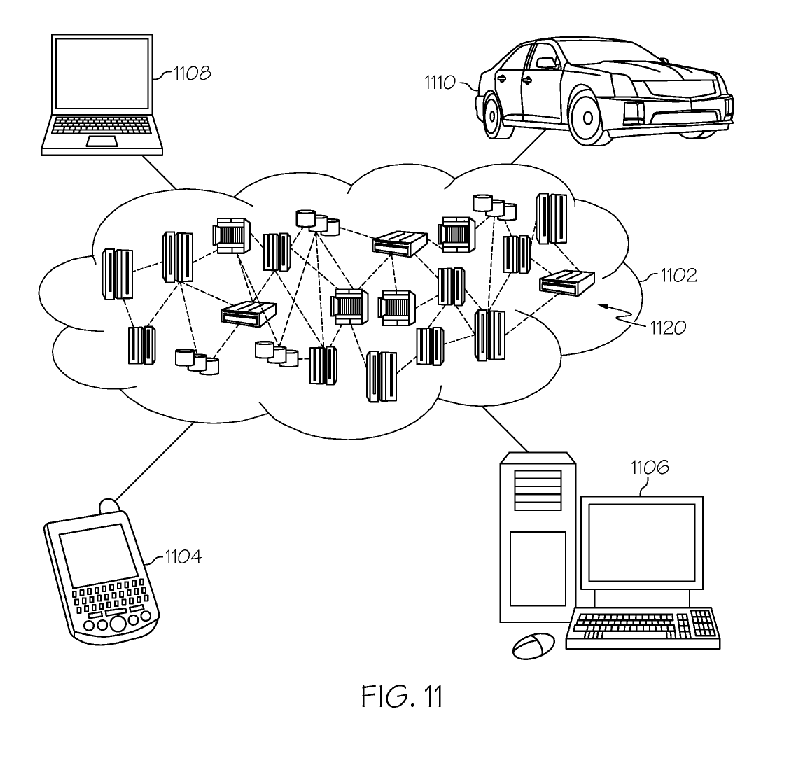

Referring now to FIG. 11, illustrative cloud computing environment 1102 is depicted. As shown, cloud computing environment 1102 comprises one or more cloud computing nodes 1120 with which local computing devices used by cloud consumers, such as, for example, personal digital assistant (PDA) or cellular telephone 1104, desktop computer 086, laptop computer 1108, and/or automobile computer system 1110 may communicate. Nodes 1120 may communicate with one another. They may be grouped (not shown) physically or virtually, in one or more networks, such as Private, Community, Public, or Hybrid clouds as described hereinabove, or a combination thereof. This allows cloud computing environment 1102 to offer infrastructure, platforms and/or software as services for which a cloud consumer does not need to maintain resources on a local computing device. It is understood that the types of computing devices 1104-1110 shown in FIG. 11 are intended to be illustrative only and that computing nodes 1120 and cloud computing environment 1102 can communicate with any type of computerized device over any type of network and/or network addressable connection (e.g., using a web browser).

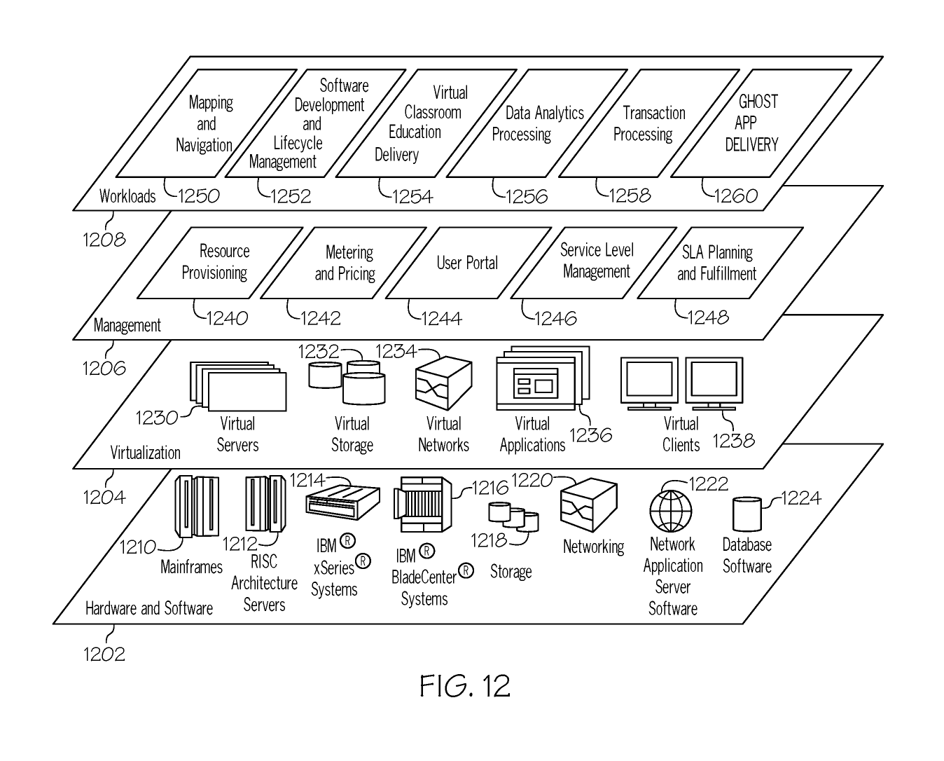

Referring now to FIG. 12, a set of functional abstraction layers provided by cloud computing environment 1202 (FIG. 12) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 1202 includes hardware and software components. Examples of hardware components include: mainframes 1210; RISC (Reduced Instruction Set Computer) architecture based servers 1212; servers 1214; blade servers 1216; storage devices 1218; and networks and networking components 1220. In some embodiments, software components include network application server software 1222 and database software 1224.

Virtualization layer 1204 provides an abstraction layer from which the following examples of virtual entities may be provided: virtual servers 1230; virtual storage 1232; virtual networks 1234, including virtual private networks; virtual applications and operating systems 1236; and virtual clients 1238.

In one example, management layer 1206 may provide the functions described below. Resource provisioning 1240 provides dynamic procurement of computing resources and other resources that are utilized to perform tasks within the cloud computing environment. Metering and Pricing 1242 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1244 provides access to the cloud computing environment for consumers and system administrators. Service level management 1246 provides cloud computing resource allocation and management such that required service levels are met. Service Level Agreement (SLA) planning and fulfillment 1248 provide pre-arrangement for, and procurement of, cloud computing resources for which a future requirement is anticipated in accordance with an SLA.

Workloads layer 1208 provides examples of functionality for which the cloud computing environment may be utilized. Examples of workloads and functions which may be provided from this layer include: mapping and navigation 1250; software development and lifecycle management 1252; virtual classroom education delivery 1254; data analytics processing 1256; transaction processing 1258; and ghost app server 1260.

### Information Processing System

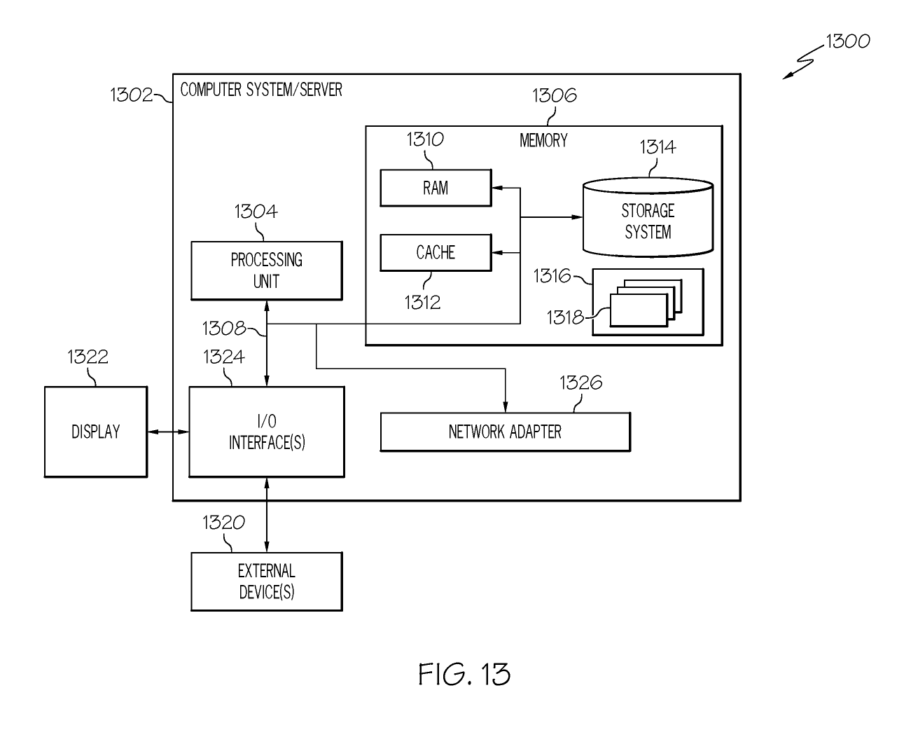

Referring now to FIG. 13, this figure is a block diagram illustrating an information processing system that can be utilized in various examples of the present disclosure. The information processing system 1302 is based upon a suitably configured processing system configured to implement one or more embodiments of the present disclosure. Any suitably configured processing system can be used as the information processing system 1302 in embodiments of the present disclosure. In another embodiment, the information processing system 1302 is a special purpose information processing system configured to perform one or more embodiments discussed above. The components of the information processing system 1302 can include, but are not limited to, one or more processors or processing units 1304, a system memory 1306, and a bus 1308 that couples various system components including the system memory 1306 to the processor 1304.

The bus 1308 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The system memory 1306 can also include computer system readable media in the form of volatile memory, such as random access memory (RAM) 1310 and/or cache memory 1312. The information processing system 1302 can further include other removable/non-removable, volatile/non-volatile computer system storage media. By way of example only, a storage system 1314 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 1308 by one or more data media interfaces. The memory 1306 can include at least one program product having a set of program modules that are configured to carry out the functions of various examples described above.

Program/utility 1316, having a set of program modules 1318, may be stored in memory 1306 by way of example, and not limitation, as well as an operating system, one or more application programs, other program modules, and program data. Each of the operating system, one or more application programs, other program modules, and program data or some combination thereof, may include an implementation of a networking environment. Program modules 1318 generally carry out the functions and/or methodologies of the above described processes and systems.

The information processing system 1302 can also communicate with one or more external devices 1320 such as a keyboard, a pointing device, a display 1322, and the like. The information processing system 1302 is further able to communicate with one or more devices that enable a user to interact with the information processing system 1302; and/or any devices (e.g., network card, modem, etc.) that enable computer system/server 1302 to communicate with one or more other computing devices. Such communication can occur via I/O interfaces 1324. Still yet, the information processing system 1302 can communicate with one or more networks such as a local area network (LAN), a general wide area network (WAN), and/or a public network (e.g., the Internet) via network adapter 1326. As depicted, the network adapter 1326 communicates with the other components of information processing system 1302 via the bus 1308. Other hardware and/or software components can also be used in conjunction with the information processing system 1302. Examples include, but are not limited to: microcode, device drivers, redundant processing units, external disk drive arrays, RAID systems, tape drives, and data archival storage systems.

### NON-LIMITING EXAMPLES

As will be appreciated by one skilled in the art, aspects of the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method on a server, the method comprising:
determining a first device context for a user device, the first device context being a context of the user device at a first timepoint;
determining a first social context for a user of the user device, the first social context being a social context of the user of the user device at a first timepoint;
determining, based on the first device context, the first social context, and a respective set of context related conditions associated with each server based app within at least one server based app, a first set of server based apps associated with a first context comprising the first device context and the first social context, the first set of server based apps being a subset of all server based apps available from the server;
sending a respective indicator of a respective user interface element for each server based app within the first set of server based apps;
receiving, at a server from the user device based on sending the respective indicator, user interface inputs associated with a selected user interface for a selected app within the first set of server based apps;
processing, based on receiving the user interface inputs, the user interface inputs to produce results based on the user interface inputs; and
sending, based on the producing, the results.

2. The method of claim 1, further comprising sending, in association with the respective indicator of the respective user interface element for each server based app within the first set of server based apps, at least one of an indication of the first context, the indication comprising an indication of the first device context and the first social context.

3. The method of claim 1, further comprising:
determining, based on the first device context and the first social context and the respective set of context related conditions associated with each server based app within the at least one server based app, a respective display position for the respective indicator of the respective user interface for at least one server based app within the first set of server based apps; and
sending to the user device, based on determining the respective display position, an indication of the respective display position for the respective indicator of the respective user interface for at least one server based app within the first set of server based apps.

4. The method of claim 1, wherein determining the first context is based at least in part on context related information received from the user device.

5. The method of claim 1, wherein determining at least one of the first device context or the first social context is based on at least one of user device location, user device movement, user device communications status, user device communications history, physiological information of a user associated with the user device, calendar entries for a user of the user device, preferences of a user of the user device, usage status of the user device, availability of resources of the user device, or information within a profile of a user of the user device, social media contacts for a user of the user device, social media activities of a user of the user device, calendar entries for a user of the user device, calendar entries for a social contact of the user of the user device, preferences of a social contact of the user of the user device, or information within a profile of a social contact of the user device.

6. The method of claim 1, further comprising:
determining a second context for the user device, the second context being a context at a second timepoint after the first timepoint and comprising a second device context and a second social context, the second context being a change in context from the first context;
determining, based on the second context and the respective set of context related conditions associated with each server based app within the at least one server based app, a second set of server based apps; and
sending, to the user device based on determining the second set of server based apps, an indication of the second context in association with a respective indicator of a respective user interface element for each app within the second set of server based apps, the indication of the second context comprising an indication of the second device context and the second social context.

7. The method of claim 1, further comprising:
determining a second context for the user device, the second context being a context at a second timepoint after the first timepoint and comprising a second device context and a second social context, the second context being a change in context from the first context;
determining that the second context does not satisfy a set of context related conditions associated with a particular app within the first set of server based apps; and
sending to the user device, based on determining that the second context does not satisfy the set of context related conditions associated with the particular app within the first set of server based apps, an indication to remove the respective user interface element for the particular app.

8. The method of claim 1, further comprising:
determining one of an activity or a predicted activity of a user of the user device,
wherein the first context further comprises the one of the activity or the predicted activity, and
wherein the determining the first set of server based apps associated with the first context is further based on the one of the activity or the predicted activity.

9. The method of claim 1, further comprising:
receiving, from a sponsor of each app within the first set of server based apps prior to determining the first context, the respective set of context related conditions for the each app within the first set of server based apps,
wherein determining the first set of server based apps associated with the first context comprises comparing the first context for the user device to each respective set of context related conditions for each app within the first set of server based apps.

10. The method of claim 9, wherein the respective set of context related conditions comprises a geographical location within a commercial area associated with the sponsor.

11. A method on a user device, the method comprising:
determining a present user device context;
determining a present social context for a user associated with the user device;
receiving, from a remote processor, a respective indicator of a respective user interface element associated with each respective server based app within a first set of server based apps, each respective indicator indicating a user interface element to display for selection of its associated server based app;
receiving, in association with the first set of server based apps, an indication of a device context and an indication of a social context;
determining that the present user device context matches the indication of a device context and the present social context matches the indications of a social context; and
displaying, based on receiving the respective indicator and based on determining that the present user device context matches the indication of a device context and the present social context matches the indications of a social context, the respective user interface element associated with each server based app within the first set of server based apps.

12. The method of claim 11, further comprising:
receiving, based on displaying the respective user interface element, a selection of a selected user interface element that is associated with a selected server based app, the selected server based app executing on the remote processor and interacting with a user interface components of the user device;
presenting on a display of the user device, based on the selection, a user interface for the selected server based app; and
exchanging with the remote processor, in conjunction with the user interface, information between the selected server based app executing on the remote processor and user interface components of the user device.

13. The method of claim 11, further comprising:
storing, in association with the indication of the device context and the indication of the social context, the respective indicator of the respective user interface element associated with each respective server based app within the first set of server based apps; and
determining, after the storing, a change in context to the present device context and the present social context,
wherein the determining that the present device context matches the indication of a device context and the present social context matches the indications of a social context is based on determining the change in context.

14. The method of claim 11, wherein the present device context comprises at least one of user device location, user device movement, user device communications status, user device communications history, physiological information of a user associated with the user device, calendar entries for a user of the user device, preferences of a user of the user device, usage status of the user device, availability of resources of the user device, physiological information of a user associated with the user device, preferences of a user of the user device, or information within a profile of a user of the user device, and
wherein the present social context comprises at least one of social media contacts for a user of the user device, social media activities of a user of the user device, calendar entries for a user of the user device, calendar entries for a social contact of the user of the user device, preferences of a social contact of the user of the user device, or information within a profile of a social contact of the user device.

15. The method of claim 11, further comprising:
determining a new present user device context, the new present user device context comprising a new device context and a new social context;
determining that the new present user device context no longer matches the indication of the device context; and
removing, based on determining that at least one of the new device context no longer matches the indication of a device context or the new social context no longer matches the indications of a social context, the respective user interface elements associated with each server based app within the first set of server based apps.

16. The method of claim 11, wherein the respective user interface element comprises an app icon.

17. The method of claim 11, wherein the selection of a selected user interface element comprises at least one of a single click, a single tap, or a single touch of the respective user interface element.

18. The method of claim 11, further comprising:
receiving, for at least one app within the first set of server based apps, a respective display location for the respective indicator of a respective user interface element associated with each respective server based app within the first set of server based apps, the respective display location specifying a respective location on a display of a plurality of interface indicators on the user device, and
wherein the displaying comprises displaying the respective indicator of a respective user interface element at the respective display location on a display of a plurality of interface indicators on the user device.

19. The method of claim 18, where in the respective display location comprises a location within a plurality of app interface indicators for installed local apps that are installed on the user device and that execute on the device.

20. A device, comprising:
determines a present device context for a user device;
determines a present social context for a user associated with the user device; and
an app user interface manager that, when operating:
receives, from a remote processor, a respective indicator of a respective user interface element associated with each respective server based app within a first set of server based apps, each respective indicator indicating a user interface element to display for selection of its associated server based app;
receives, in association with the first set of server based apps, an indication of a device context and an indication of a social context;
determines that the present device context matches the indication of a device context and the present social context matches the indications of a social context; and
displays, based on receiving the respective indicator and based on determining that the present device context matches the indication of a device context and the present social context matches the indications of a social context, the respective user interface element associated with each server based app within the first set of server based apps.
